(19) United States
(12) Patent Application Publication
(10) Pub. No.: US 2022/0378061 A1
(43) Pub. Date: Dec. 1, 2022

(54) METHOD OF MANUFACTURING BEVERAGE INGREDIENTS

(71) Applicant: Koninklijke Douwe Egberts B.V., Utrecht (NL)

(72) Inventors: Gertjan Heijman, Utrecht (NL); Rebecca Van Der Westen Skogvold, Utrecht (NL); Thomas Frank Hofmann, Freising (DE); Oliver Frank, Freising (DE); Michael Josef Gigl, Freising (DE)

(21) Appl. No.: 17/787,551

(22) PCT Filed: Dec. 18, 2020
(86) PCT No.: PCT/EP2020/087010

§ 371 Date: Jun. 20, 2022

(30) Foreign Application Priority Data
Dec. 20, 2019 (GB) 1919001.6

(51) Int. Cl. A23F 5/36; A23F 5/50; A23F 5/32; A23F 5/34

(52) U.S. Cl. CPC A23F 5/36; A23F 5/505; A23F 5/32; A23F 5/34

(57) ABSTRACT

The invention provides a method of treating a beverage ingredient extract comprising the steps of: a. filtering a beverage ingredient extract to obtain a beverage ingredient extract retentate and a beverage ingredient extract permeate; b. raising the pH of said beverage ingredient extract retentate to provide a treated beverage ingredient extract retentate; and c. combining said treated beverage ingredient extract retentate with said beverage ingredient extract permeate to generate a recombined ingredient extract.

### TECHNICAL FIELD OF THE INVENTION

The present invention relates to a method of treating a beverage ingredient extract and a beverage ingredient extract obtained by the method. The invention further relates to beverage ingredient extract.

### BACKGROUND TO THE INVENTION

Instant coffee powder is a soluble coffee powder particularly appreciated by consumers for its convenience as it allows an easy and quick preparation of coffee beverages. It is nevertheless considered by consumers as less aromatic in comparison to freshly brewed coffee preparations, which are perceived as richer in aroma, with a higher mouthfeel (less watery) and with a more premium quality.

There is a constant increase in the demand for an instant coffee powder with a premium perception and a higher in-cup quality, e.g., with an aroma content comparable to that of a roasted and freshly ground brewed preparation.

The poor quality perceived in conventional instant coffee powder by consumers is mainly due to the standard processes used in the manufacturing of said soluble coffee powder. These processes usually comprise multiple steps, each of which can cause a partial loss of volatile organic compounds (VOC), i.e., the aroma compounds, which are characteristic of any coffee preparation.

Conventional manufacturing processes for instant coffee powder are complex and as mentioned above, comprise several steps. A first step is, generally the generation of an aqueous coffee extract from roast and ground coffee powder which is extracted with water at a high temperature (for example between 100-220° C.). The resulting freshly brewed extract is then sent to an aroma recovery step in which the aroma compounds responsible for the freshly brewed aroma are stripped away in order to be stored and added back later, enriching the final product with freshly brewed aromatic notes. The stripped extract is concentrated to produce a liquid coffee and once the aroma compounds are added back, it is finally sent to a drying process (freeze drying and/or spray drying) to produce instant coffee powder. High temperature is commonly used to increase the extraction yield of the process, as the extract obtained through high temperatures presents a high concentration of molecules with high molecular weight (HMW) compounds, and particularly melanoidins, which are directly linked to a better in-cup mouthfeel perception of the resulting instant coffee powder when dissolved in water.

Recent studies have demonstrated that these high molecular weight (HMW) compounds, particularly melanoidins, are also responsible for a binding activity towards the volatile organic compounds (VOC), i.e., the aroma compounds of roast and ground coffee extracts. In fact, it has been proven that certain aroma compounds, which play a key role in the aroma perception of any coffee beverage (for instance aldehydes, hydroxyphenols, thiols and pyrazines) are bound by the high molecular weight (HMW) compounds present in said coffee extracts, such as melanoidins, resulting in less aromatic and/or stale coffee extracts and consequently resulting in less aromatic liquid coffee concentrates and/or instant coffee powder.

It is therefore crucial for the manufacturing of a high in-cup quality liquid coffee concentrates and/or instant coffee powder to find the right balance between on one hand reducing the aroma compound binding activity by the high molecular weight (HMW) compounds and on the other hand obtaining a high yield coffee extract which then provides a good in-cup mouthfeel and aroma.

There are currently few, if any, effective solutions to prevent the aroma-HMW compound binding effect, other than limiting or reducing the amount of extraction of dry matter, i.e., the yield of the extraction process, resulting in a less cost-effective manufacturing process and a poorer in-cup quality of the liquid coffee concentrate and/or instant coffee powder, with a resulting beverage perceived as watery.

Other conventional methods make use of an aroma recovery step to address the issue of a low aromatic and therefore low quality perceived instant coffee powder, stripping the aroma from the freshly brewed coffee extract before concentration and adding it back before the drying process (spray drying or freeze drying). However, an aroma recovery step is a complex and expensive step of the manufacturing process and requires expertise and a high consumption of power/energy.

It would be therefore advantageous to provide a method to inhibit the agonistic effect of the HMW compounds, whilst retaining key aroma compounds in the final coffee product.

It would also be advantageous to provide a method that ensures fewer aroma compounds are bound by the HMW compounds, particularly melanoidins, reducing the binding activity between these two species.

It would be furthermore advantageous to provide a method to increase quality of an instant coffee powder with a reduced manufacturing complexity and cost, reducing the aroma recovery step or not including it at all.

It would be therefore advantageous to provide a method which can be applied to any conventional extraction method for the production of aqueous coffee extracts, i.e., for example one stage and/or two stages processes.

It would be furthermore advantageous to provide a liquid coffee concentrate and/or an instant coffee powder with an in-cup mouthfeel comparable to freshly brewed coffee preparations, which also has an aroma complexity and content indicative of freshly brewed beverages.

It would also be advantageous to provide a method to at least partially release bound aroma compounds from HMW compounds in order to improve the in-cup performance of a coffee product (instant coffee powder and/or coffee concentrate) for coffee beverage preparations.

It is therefore an aim of embodiments of the invention to satisfy the highly-felt need of an optimised method for the production of a high-quality instant coffee powder and/or coffee concentrate and/or to overcome or mitigate at least one problem of the prior art whether disclosed herein or not.

### SUMMARY OF THE INVENTION

According to a first aspect of the invention there is provided a method of treating a beverage ingredient extract comprising the steps of: a) filtering a beverage ingredient extract to obtain a beverage ingredient extract retentate and a beverage ingredient extract permeate; b) raising the pH of the beverage ingredient extract retentate to provide a treated beverage ingredient extract retentate; and c) combining said treated beverage ingredient extract retentate with said beverage ingredient extract permeate to generate a recombined ingredient extract.

The beverage ingredient extract is preferably coffee extract.

Without being bound by any theory, it is believed that the step of raising the pH of the beverage ingredient extract retentate (particularly coffee extract retentate) creates conditions in which phenolic compounds, such as hydroxycinnamic acids (“HCA”), including caffeic acid, ferulic acid and p-coumaric acid, are released from high molecular weight compounds (HMWs), such as melanoidins and arabinoxylans, of the retentate. The reduction of HCA in the retentate reduces the subsequent binding of aroma molecules to the HCA compounds, and therefore more aroma is available to the combined extract when the retentate and permeate are combined, creating a product with a more desired coffee aroma. In other words, it is believed that acidic hydrolysis leads to a cleavage of aromatic (e.g. HCAs) compounds and as a consequence to a reduction of π-π interactions If there are fewer binding partners on the melanoidins in the form of HCAs, then less non-covalent interactions with odorants like FFT or pyrazines can be formed

In a further embodiment the method may further comprise after step b) the step of filtering said treated beverage ingredient extract retentate to further purify it.

In another embodiment the method may comprise the step of removing aroma volatile compounds from the beverage ingredient extract before step a) and adding said aroma volatile compounds back after step c). Removing said aroma volatile compounds may comprise stripping, and/or steam distilling.

In some embodiments, step a) may be carried out at a temperature in the range of 15 to 70° C., which may be at a pressure in the range of 1 to 3 bar.

Step a) may be carried out by means of at least one filtering member.

Said at least one filtering member may comprise at least one membrane, which may comprise at least one size exclusion cut off of at least 5 kDa or preferably at least 10 kDa.

Said filtering member may comprise a membrane, and/or a sequence of membranes. In a preferred embodiment said membrane may comprise a size exclusion membrane.

In some embodiments, said size exclusion membrane may comprise a size exclusion cut off of about 50 kDa, 40 kDa, 30 kDa, 20 kDa, 10 kDa or 5 kDa.

In some embodiments, said filtering member may comprise a plurality of filtering members. In a further embodiment said plurality of filtering means may comprise a plurality of membranes. Said plurality of membranes may comprise a plurality of size exclusion membranes which may comprise a combination of different pore size distributions, i.e. different cut offs. The combination of cut offs may comprise any combination of pore size distributions of about 50 kDa, 40 kDa, 30 kDa, 20 kDa 10 kDa, and/or 5 kDa. In preferred embodiments at least one size exclusion membrane comprises a pore size distribution (or cut-off) of around 50 kDa.

In some embodiments, performing step b) may comprise treating the ingredient extract retentate with a pH-raising means which may confer to the extract a pH value in the range 7 to 14, preferably 7 to 13, more preferably 7 to 11. In some embodiments the pH is raised to between 7-11 or between 7-10. In particularly preferred embodiments the pH is raised to between 7 and 9. Whilst higher pH values release more HCA molecules and potentially prevent more aroma binding to the retentate, pH values higher than around 11 may be less desired industrially due to cost and handling implications, and so a pH of 11 or lower is preferred as giving excellent results whilst resulting in fewer potential cost and handling implications; but pH 11-13 can be used in some embodiments. Said pH-raising means may be in the form of an alkaline aqueous solution which may comprise an aqueous NaOH solution, for example; and/or resin; and/or absorber treatment; and/or a combination thereof.

Step b) may comprise treating the ingredient extract retentate with a pH-raising means for a period of time in the range of 10 to 180 minutes, preferably 30 to 100 minutes, more preferably between 30 to 90 minutes, most preferably between 30 and 60 minutes, and may comprise stirring the ingredient extract retentate while treating it with said pH-raising means, and preferably also raising the temperature (of the ingredient extract retentate) at a value in the range of 30 to 120° C. (while treating it with said pH-raising means), preferably between 60 to 90° C. In a particularly preferred embodiment, the temperature is around 60° C. and the time is around 60 minutes.

In a further embodiment, the method may further comprise the step of filtering the beverage ingredient extract permeate at least once, after step a), to produce further extract retentate and combining one or more further extract retentate and the beverage ingredient extract retentate before performing step b).

In some embodiments, each repeat filtering of the beverage ingredient extract permeate may comprise using a filtering member with reduced pore size compared to any previous filter step.

In further embodiments, the method may further comprise the step of filtering the generated recombined ingredient extract at least once, to provide a secondary beverage ingredient permeate and a secondary beverage ingredient retentate and treating said secondary beverage ingredient retentate with a pH-raising means.

In some embodiments, the beverage ingredient extract may comprise a primary extract from a primary extraction process of a roast and ground coffee powder, and/or a secondary extract extracted from spent grounds resulting from the primary extraction process, in a secondary extraction process and/or tertiary extract from the extraction of the resulting spent ground coffee powder from the secondary extraction process and/or a combination thereof. The beverage ingredient extract may comprise between 2% wt. and 15% wt. concentration of soluble solids. In some embodiments the beverage ingredient extract may comprise between 15% wt. and 80% wt. concentration of soluble solids.

In some embodiments the method may further comprise the step of drying said recombined ingredient extract to generate a soluble beverage ingredient powder. Said drying step may comprise spray-drying and/or freeze-drying said recombined ingredient extract.

In some embodiments said beverage ingredient extract may comprise an extract obtained from a beverage ingredient selected from the group of coffee, cocoa, chicory, tea, and beer.

In some embodiments the recombined beverage ingredient extract may be converted into soluble beverage ingredient powder.

According to a second aspect of the invention there is provided a beverage ingredient extract obtained or obtainable by the method of the first aspect of the invention.

In some embodiments said beverage ingredient extract may comprise between around 2% wt. and 15% wt. concentration of soluble solids (so called ‘dilute’ extract).

In some embodiments said beverage ingredient extract may comprise between around 15% wt. and 80% wt. concentration of soluble solids (so called ‘concentrated’ extract).

Said beverage ingredient extract of the second aspect of the invention may comprise a beverage ingredient selected from the group of coffee, cocoa, chicory, tea, and beer.

According to a third aspect of the invention there is provided a coffee extract obtained or obtainable by the method of the first aspect of the invention.

According to a fourth aspect of the invention there is provided use of a beverage ingredient extract comprising high molecular weight compounds in which the high molecular weight compounds of molecular weight above one of more of the group comprising 5 kDa, 10 kDa, 20 kDa, 30 kDa, and 50 kDa have been treated in a pH-raising step, to reduce aroma binding to said extract.

Preferably the beverage ingredient extract is as described and defined hereinabove, and more preferably is a coffee extract. Preferably at least the high molecular weight compounds of above 50 kDa have been treated in a pH-raising step.

### DETAILED DESCRIPTION OF THE INVENTION

In order that the invention may be more clearly understood, embodiments thereof will now be described, by way of example only, with reference to the accompanying drawings of which:

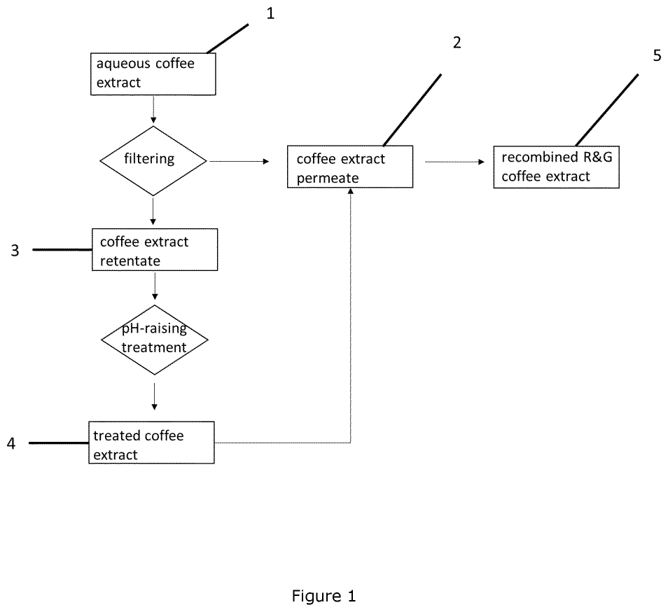

FIG. 1 illustrates a schematic flow diagram of a first embodiment of a method according to the first aspect of the invention;

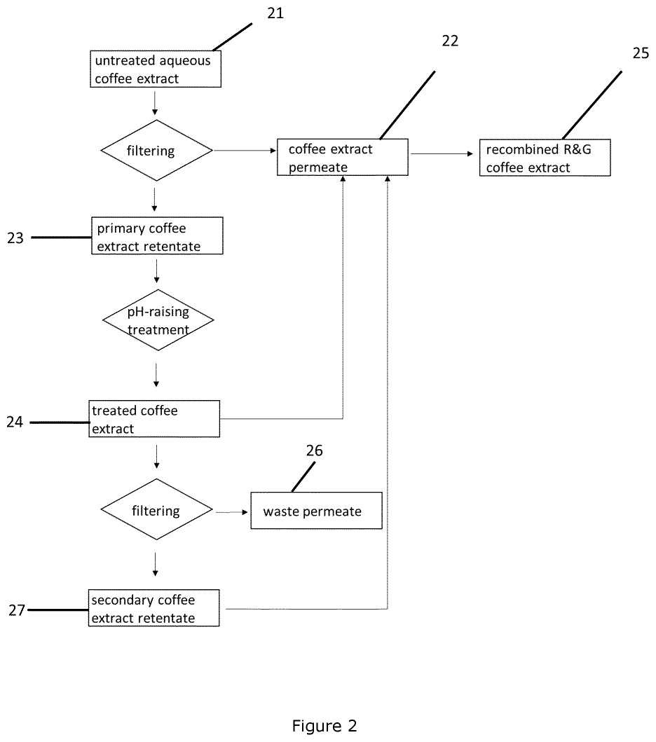

FIG. 2 illustrates a schematic flow diagram of a second embodiment of a method according to the first aspect of the invention;

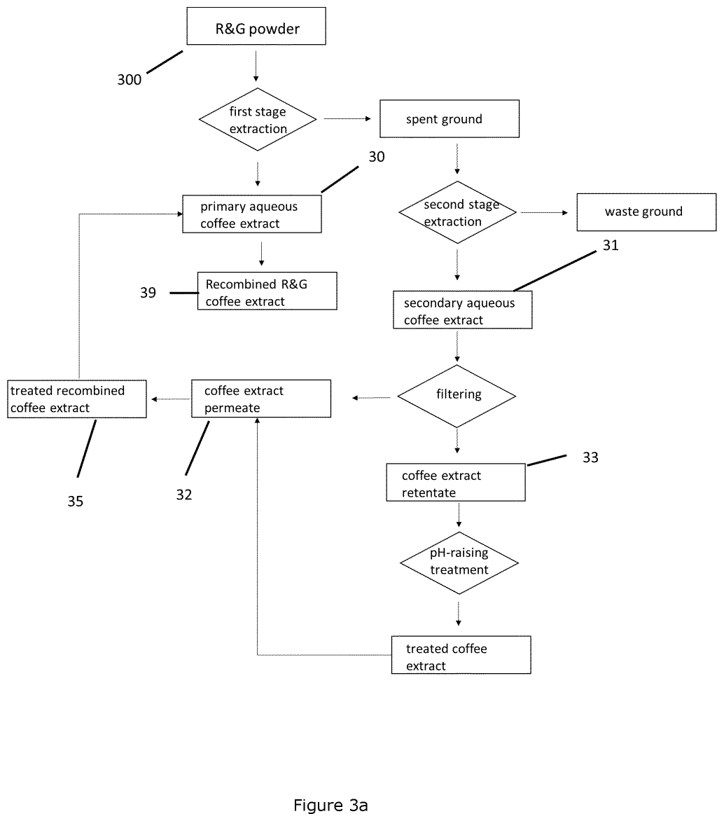

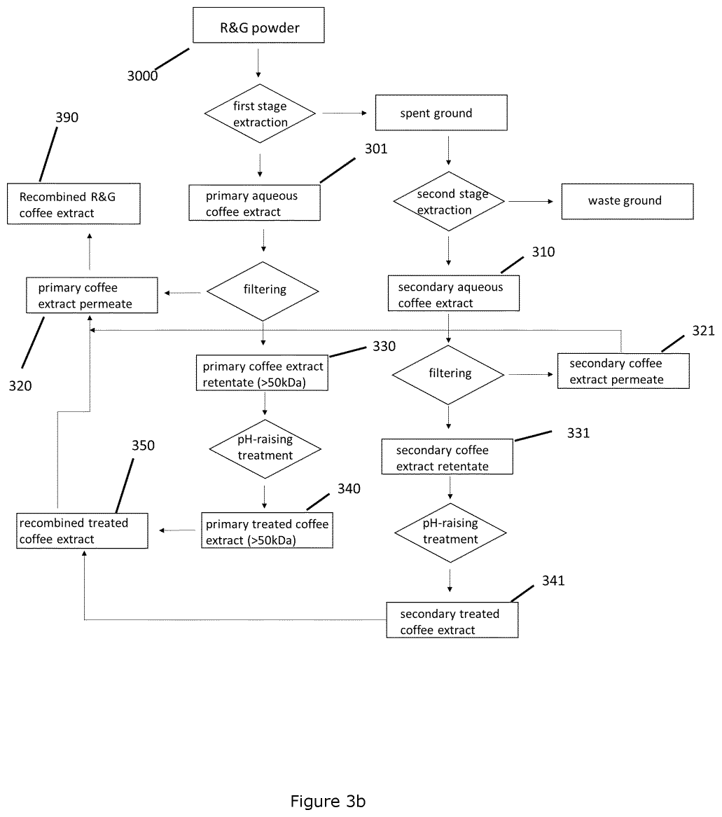

FIG. 3a illustrates a schematic flow diagram of a third embodiment of a method according to the first aspect of the invention;

FIG. 3b illustrates a schematic flow diagram of a fourth example of a method according to the first aspect of the invention;

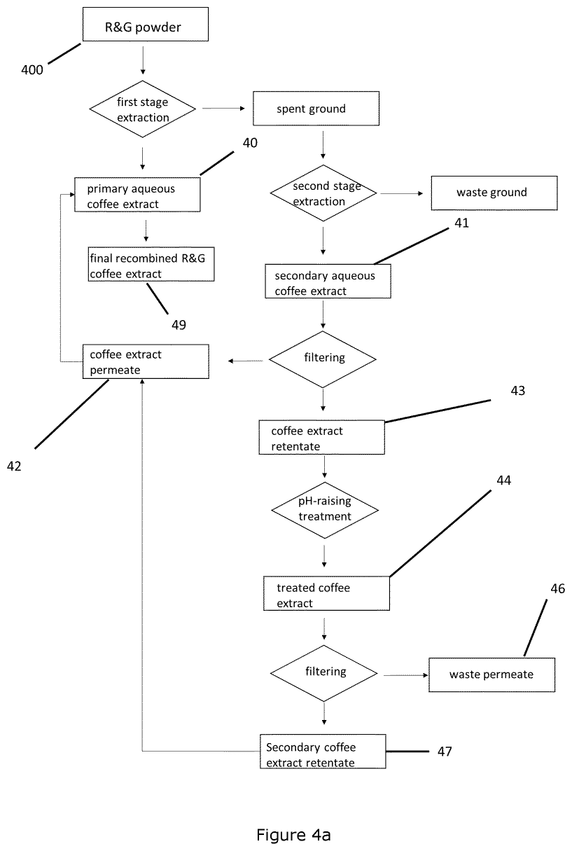

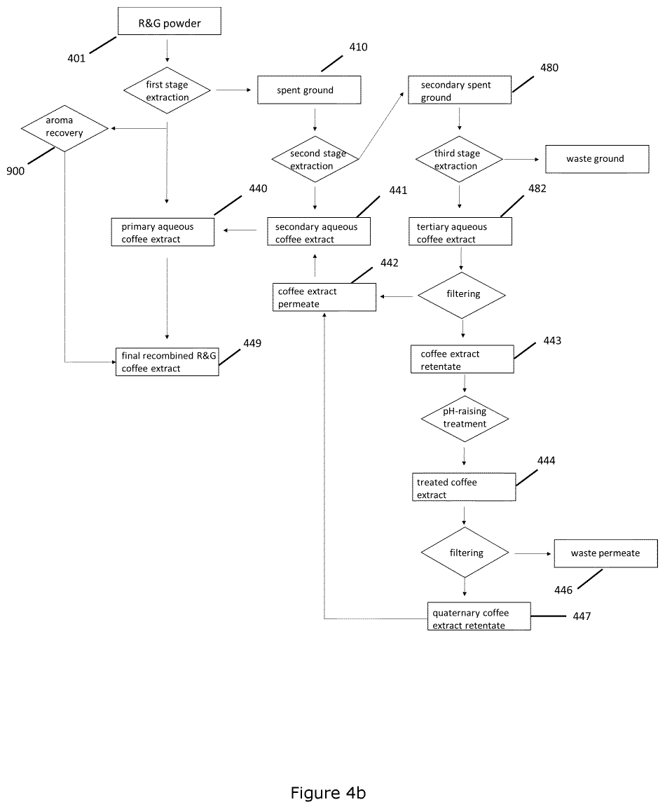

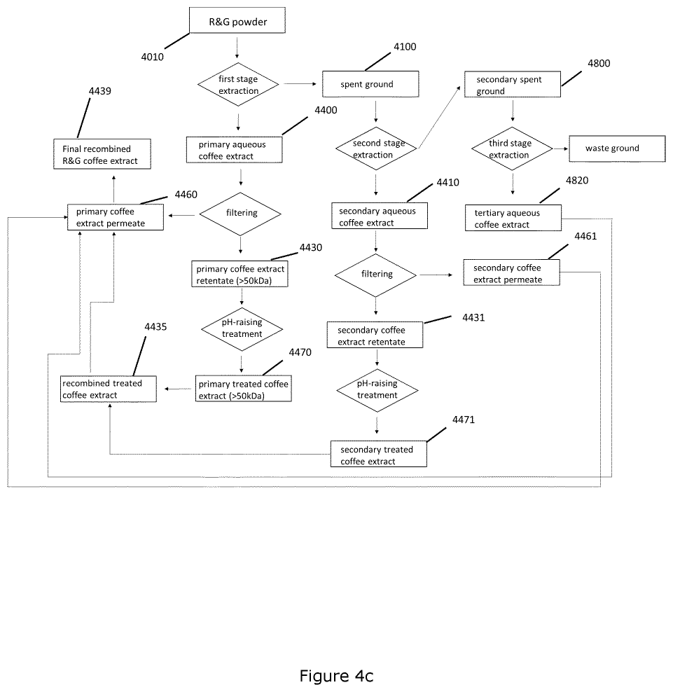

FIG. 4a illustrates a schematic flow diagram of a fifth embodiment of a method according to the first aspect of the invention;

FIG. 4b illustrates a schematic flow diagram of a sixth embodiment of a method according to the first aspect of the invention;

FIG. 4c shows a schematic of a flow diagram of a seventh example of a method according to the first aspect of the invention;

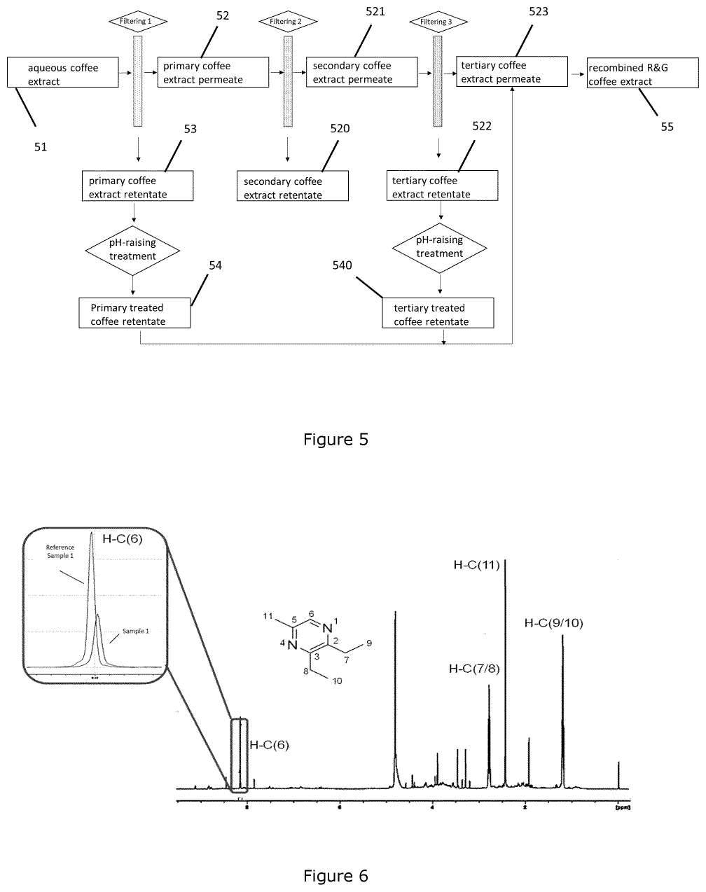

FIG. 5 illustrates a schematic flow diagram of an eighth embodiment of a method according to the first aspect of the invention;

FIG. 6 illustrates a ¹H-NMR spectrum of a coffee beverage obtained from commercially available coffee concentrate and of a reference sample, both spiked with 2,3-diethyl-5-methylpyrazine, according to a reference HMW binding effect study;

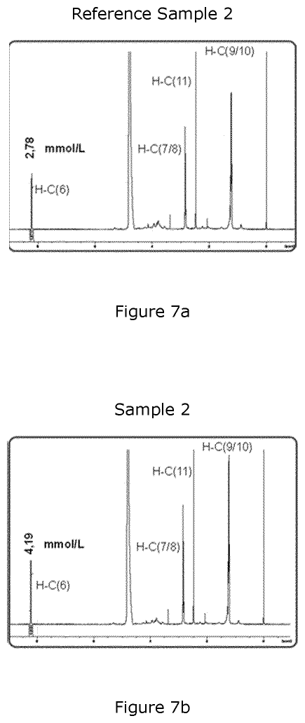

FIGS. 7a and 7b illustrate a ¹H-NMR spectrum of a coffee beverage obtained from commercially available coffee concentrate spiked with 2,3-diethyl-5-methylpyrazine, before and after pH-raising treatment, according to a reference HMW binding effect study;

Referring to Figures, like numbers represent like components.

### Definitions

An “beverage ingredient extract” is a solution comprising soluble beverage ingredient compounds extracted from a beverage ingredient. This is usually obtained by contacting a beverage ingredient powder or granules, with water, typically hot water or steam. Depending on the temperature and pressure used for the extraction, the yield of soluble beverage ingredient compounds obtained from the beverage ingredient powder will vary. High temperatures may result in high yields, hydrolysing complex carbohydrates in the beverage ingredient into soluble components. While high yields are obviously desirable for commercial production, they also result in the production of high concentration of high molecular weight (HMW) compounds. The beverage ingredient may comprise an ingredient selected from the group of roast and ground coffee, cocoa powder, chicory, tea and/or beer.

By “high molecular weight compounds” (HMW) it is meant compounds present in a beverage ingredient extract with a molecular weight of at least about 5 kDa, such as above 10 kDa, 20 kDa, 30 kDa, preferably 40 kDa, even more preferably 50 kDa.

By “low molecular weight compounds” (LMW) it is meant compounds present in a beverage ingredient extract with a molecular weight which is less than about 5 kDa, preferably less than 4 kDa, more preferably less than 1 kDa,

By a “liquid ingredient concentrate” it is meant a concentrated solution comprising soluble ingredient solids, suitable for dilution to obtain a desired beverage. By a “liquid coffee concentrate” it is meant a concentrated solution comprising soluble coffee solids, suitable for dilution to obtain a desired coffee beverage. Liquid coffee concentrates are often sold as so-called bag-in-box products for dilution in vending machines or are dried to produce instant coffee powder to obtain coffee beverages. A liquid coffee concentrate can be obtained by conventional concentration processes (as for instance evaporation, filtration, distillation, cryo-concentration applied to an aqueous coffee extract and may comprise 6 to 80% wt. coffee solids preferably 10 to 65% wt., more preferably 15 to 50% wt. coffee solids.

### Example 1

FIG. 1 represents a flow diagram of a first example of a method of the first aspect of the invention.

An aqueous coffee extract (1) is filtered to obtain a coffee extract permeate (2) and a coffee extract retentate (3). The coffee extract permeate (2) is stored for further use while the coffee extract retentate (3) is sent to a treatment with pH-raising means in the form of an alkaline solution to generate a treated coffee extract (4). Said treated coffee extract (4) is then recombined with said coffee extract permeate (2) to generate a recombined roast and ground coffee extract (5). The aqueous coffee extract (1) is provided, through a conventional method, for example by contacting instant roast and ground coffee powder with hot water at a temperature in a range between 100° C. and 220° C. (or alternatively by cold brew extraction at less than 100° C., preferably less than 80° C.). The extraction is carried out in a conventional extraction vessel (not shown), such as for example a packed column containing roast and ground coffee powder. The extraction can be carried out in batch or continuously and a plurality of columns can be used to increase extraction yield. Hot water is sent into said column/columns through the roast and ground coffee powder from the top or alternatively from the bottom of the column/columns. Time of extraction varies on the basis of the number of columns used, the grind size of the roast and ground coffee powder and the desired extraction yield. The content of HMW compounds in the aqueous coffee extract (1) is in the range of 10-30%, particularly of 10-25%.

The aqueous coffee extract (1) is sent to filtration means through a conventional pipes system (not shown). In some embodiments, the filtration means is in the form of any conventional method of filtering a liquid which generates a retentate fraction (i.e. a fraction which is retained by the filtering means) and a permeate fraction of said liquid (i.e. a fraction of liquid which passes through the filtering means). Filtration methods are based on size exclusion: the physical structure of the filtering means allows the selective passage of molecules with a dimension smaller than the critical size of the pores of the filtering means, while cutting off molecules with dimensions greater than these pores. Filtering means may for instance comprise membranes, but any other conventional method which allows separations of liquid fractions on the base of molecular size are herein considered. For instance, sequential ultrafiltration, nanofiltration, osmosis, pervaporation, diafiltration, centrifugation, dialysis, chromatography and resin technology. In a preferred embodiment of the invention, the filtration means is a membrane filtration system using a membrane with a molecular weight cut off of about 50 kDa. In these conditions, compounds with a molecular weight greater that 50 kDa are retained by the membrane (forming the so-called retentate) while compounds with a lower molecular weight can pass through the membrane itself (generating the so called permeate). The filtering process is carried out at a temperature of 15-70° C. and a pressure of 1-3 bar for a period of time of 1-8 hours. From the filtration process the coffee extract permeate (2) and the coffee extract retentate (3) are obtained. The concentration of HMW compounds in the coffee extract retentate (3) is higher than the concentration of HMW compounds in the aqueous coffee extract (1), particularly the concentration of HMW compounds in the coffee extract retentate (3) is more than double the concentration of HMW compounds in the aqueous coffee extract (1) and can be up to 10-fold higher.

In some embodiments, the membrane cut off is less than 50 kDa, for example 30 kDa, 20 kDa, 10 kDa or 5 kDa.

The coffee extract permeate (2) of FIG. 1 is stored in condition of low temperature and reduced oxygen presence to prevent it from staling, while the coffee extract retentate (3) is sent for pH-raising treatment with alkaline solution to reduce the affinity toward the aroma compounds of HMW compounds, responsible for the binding activity of the aroma compounds present in any coffee extract and particularly in the coffee extract permeate (2) of the invention. The pH-raising treatment is carried out by adding to the primary coffee extract retentate (3) a solution of sodium hydroxide (NaOH) in a conventional vessel. The resulting mixture is stirred for a time of 30 to 180 minutes, at a temperature of 30 to 100° C. (preferably 30-60 minutes at 60-90° C.). The pH of the sodium hydroxide solution (NaOH) is in the range of 7 to 14, preferably 8 to 11. The concentration of said solution is in the range of 0.5 to 5 mol/L (5M). Alternative alkaline solutions can be used, for instance NaHCO₃, H₂CO₃ or KOH. The treated coffee retentate (4) obtained from this alkaline treatment shows a reduced binding activity toward the aroma compounds, i.e. the volatile organic compounds (VOC). Without being bound by theory, an explanation to this reduced binding activity effect of the HMW compounds after treatment with alkaline agent can be found in the fact that the alkaline environment, the high temperature and the prolonged time of the treatment facilitate the breaking up of the bonds (particularly ester bonds of the phenolic groups responsible for the binding effect toward the aroma components and which are present on the steric arrangement of the long chains of said high molecular weight (HMW) compounds. By decreasing said phenolic groups on the steric arrangement of the long chains of said high molecular weight (HMW) compounds by way of the alkaline treatment the binding activity with regards to the aroma compounds in the treated coffee extract (4) is reduced.

Further alternative pH-raising treatments can be used. For example, the pH-raising treatment may be performed using an ion exchange resin and/or an absorber. The absorber may be carbon based, polyacrylate based or polystyrene based. Examples of commercial absorbers include Purolite® MN 200, Purolite® MN 202, and Lewatit® AF5. Examples of ion exchange resins include strong or weak basic anion exchange resins. Preferably, the ion exchange resin is a weak basic anion exchange resin. The resin may be based on polyacrylate or polystyrene, preferably polyacrylate. The functional groups may be selected from the group of amine functional groups, such as primary, tertiary, and quaternary amine groups as well as polyamine groups, preferably tertiary amine groups. The pH value range of the extract after pH-raising treatment is in the range of 7 to 14, preferably 8 to 11.

After the pH-raising treatment with the alkaline solution, the treated coffee extract (4) of FIG. 1 shows a reduced content of said phenolic groups on the steric arrangement of the long chains of the HMW compounds. This value is in the range of 10-50% reduction.

The pH of the treated coffee extract (4) after pH-raising treatment is in the range of 4.9-5.8, following quenching after hydrolysis.

The treated coffee retentate (4) of FIG. 1 is then sent though a conventional pipes system to be recombined with the coffee extract permeate (2) to result in the recombined roast and ground coffee extract (5) having a content of phenolic fraction less than the original aqueous coffee extract (1) and having a reduced binding activity towards aromatic compounds compared to the aqueous coffee extract (1) itself.

Said roast and ground coffee extract (5) is now ready to be used in conventional manufacturing processes for the production for example of ready to drink products or alternatively it is sent to conventional manufacturing processes for the production of liquid coffee concentrates and/or instant coffee powder (not shown). These processes comprise a step of concentrating the roast and ground coffee extract (5) to 6 to 80% wt. coffee solids, preferably 10 to 65% wt., more preferably 15 to 50% wt coffee. The concentration step is carried out with standard and commercially available methods as for instance evaporation, cryo-concentration and centrifugation. The liquid coffee concentrate is then sent to a packaging process to be packed in bag-in-box package, for example, ready to be sold for using in vending machines.

Alternatively, the liquid coffee concentrates are sent to a further process of drying where the liquid coffee concentrates are transformed in instant coffee powder through conventional spray-drying or freeze-drying processes.

### Example 2

Referring now to FIG. 2, it represents a flow diagram of a second example of a method of the first aspect of the invention.

In summary, an aqueous coffee extract (21) is filtered to obtain a coffee extract permeate (22) and a primary coffee extract retentate (23). The coffee extract permeate (22) is stored for later use and the primary coffee extract retentate (23) is sent to a pH-raising treatment with alkaline solution generating a treated coffee extract (24). Said treated coffee extract (24) is sent to a further filtration process to generate a secondary coffee extract retentate (27) and a waste permeate (26). Said secondary coffee extract retentate (27) is then recombined with the coffee extract permeate (22) to generate a recombined roast and ground coffee extract (25).

The detailed process of Example 2 is as follows.

The aqueous coffee extract (21) provided through conventional extraction methods as described in Example 1, is filtered to generate a coffee extract permeate (22) which is stored for further uses and a primary coffee extract retentate (23). The filtration means is of the type as described for Example 1 and involves conventional membrane filtration system which comprises a membrane filtration, for example, with a cut off of about 50 kDa. The filtering process is carried out at a temperature of 15-70° C. and a pressure of 1-3 bar, for a period of time of 1-8 hours. Alternative filtration methods as described in Example 1 are available. The concentration of HMW compounds in the primary coffee extract retentate (23) is higher than the concentration of HMW compounds in the aqueous coffee extract (21), particularly the concentration of HMW compounds in the primary coffee extract retentate (23) is more than double (and can be up to 10-fold) the content of HMW compounds in the aqueous coffee extract (21).

In some embodiments, the membrane cut off is less than 50 kDa, for example about 30 kDa, 20 kDa, 10 kDa or 5 kDa.

The primary coffee extract retentate (23) is sent for pH-raising treatment with alkaline agent, reducing the agonistic effect of phenolic groups of the high molecular weight (HMW) compounds, responsible for the binding activity of the aroma compounds in coffee extracts. As described for Example 1, the alkaline treatment comprises:
i. adding a solution of sodium hydroxide (NaOH) to the primary coffee extract retentate (23) and
ii. stirring for 30 to 180 minutes at a temperature of 30 to 100° C.

The pH of the sodium hydroxide solution (NaOH) is in the range of 7 to 14, preferably 8 to 11 (concentration of 0.5-5 mol/L).

Alternative alkaline agents can also be used, as well as alternative resins and/or absorber treatments as described in Example 1.

The pH of the obtained treated coffee extract (24) after pH-raising treatment is in the range of 4.9 to 5.8 following quenching after hydrolysis.

The treated coffee extract (24) shows a reduced binding activity toward the aroma compounds.

The treated coffee extract (24) is then sent though conventional pipes system to a further filtration process to generate and separate a secondary coffee extract retentate (27) from a waste permeate (26), waste permeate (26) consisting of a fraction of coffee extract with primarily compounds with a molecular weight less than 5 kDa (in the range of low molecular weight, LMW, compounds).

When the treated coffee extract (24) of FIG. 2 is sent to the further filtration process the filtering means may be a conventional membrane with a cut-off of 1 kDa, but any alternative filtration method is suitable.

The resulting secondary coffee extract retentate (27) is then recombined with the coffee extract permeate (22) to result in the recombined roast and ground coffee extract (25) with a concentration of phenolic groups less than the aqueous coffee extract (21) and therefore with a reduced binding activity towards aromatic compounds compared to the aqueous coffee extract (21). In some embodiments the treated coffee extract (24) is sent directly for addition to the coffee extract permeate (22) without pass through the filtration step to separate the waste permeate (26) generating the recombined roast and ground coffee extract (25).

Said recombined roast and ground coffee extract (25) is then sent to conventional manufacturing processes for the production of ready to drink, liquid coffee concentrates and/or instant coffee powder.

The concentration process for the manufacturing of liquid coffee concentrate and/or instant coffee powder is carried out as described for Example 1. The liquid coffee concentrate is then sent to a packaging process, to be packed in bag-in-box packaging for example, or to a drying process (spray drying or freeze drying) for the production of instant coffee powder.

### Example 3a

FIG. 3a shows a schematic of a flow diagram of a third example of a method according to the first aspect of the invention.

A two-stage extraction process is applied to roast and ground coffee powder (300). A first extraction is undertaken to produce a primary aqueous coffee extract (30) and so-called “spent ground”. A secondary extraction is performed on the spent ground to produce a secondary aqueous coffee extract (31). Said secondary aqueous coffee extract (31) is then filtered to obtain a coffee extract retentate (33) and a coffee extract permeate (32) the coffee extract retentate (33) being treated according to the first aspect of the invention, as described in Example 1, to generate a treated roast and ground coffee extract (35) which is then recombined with the primary aqueous coffee extract (30) to obtain finally a recombined roast and ground coffee extract (39).

In some embodiments, said two-stage extraction process comprises an extraction process for the production of aqueous coffee extracts in which the extraction is carried out in two stages at different temperatures. In a first stage the extraction is carried out at a lower temperature. The roast and ground coffee powder (300) is extracted with water in the range of 20° C. to 140° C. In a second stage the roast and ground coffee powder left after the first stage (also called “spent ground”) is then re-extracted with water at a higher temperature, in the range of 170° C. to 220° C. The extract obtained from the first stage is also called primary aqueous coffee extract (30), while the extract from the second stage at higher temperature is also called secondary aqueous coffee extract (31). The secondary aqueous coffee extract (31) may be characterised based on the chemical components present in the extract. For example, secondary aqueous coffee extract (31) may be considered one which has a level of high molecular weight (HMW) compounds in the range of 10-40%. Similarly, the primary aqueous coffee extract (30) is characterised based on the level of high molecular weight (HMW) compounds around 5-20%. The two-stage extraction process enables an increased extraction yield compared to a conventional one-stage extraction process due to a high content of high molecular weight (HMW) compounds.

The final recombined roast and ground coffee extract (39) shows a reduced binding activity of HMW compounds towards the aroma compounds resulting in a high content of free aroma compounds.

Said final recombined roast and ground coffee extract (39) is then sent to conventional manufacturing processes for the production of ready to drink, liquid coffee concentrates and/or instant coffee powder.

The concentration and the packaging steps are carried out as described for Example 1.

### Example 3b

FIG. 3b shows a schematic of a flow diagram of a fourth example of a method according to the first aspect of the invention.

A two-stage extraction process is applied to roast and ground coffee powder (3000). A first extraction is undertaken to produce a primary aqueous coffee extract (301) and so-called “spent ground”. A secondary extraction is performed on the spent ground to produce a secondary aqueous coffee extract (310). Said primary aqueous coffee extract (301) and said secondary aqueous coffee extract (310) are then filtered to obtain, a primary coffee extract permeate (320), a secondary coffee extract permeate (321), a primary coffee extract retentate (330), a secondary coffee extract retentate (331). The remaining extracted roast and ground coffee powder from the second extraction stage (so called ‘waste ground’) is discharged or sent to further industrial uses. The coffee extract retentates (330, 331) are treated according to the first aspect of the invention, as described in Example 1, to generate a primary and secondary treated coffee extract (340 and 341 respectively) which are then recombined to obtain a recombined treated coffee extract (350). Said recombined treated coffee extract (350) is finally added to the primary coffee extract permeate (320) and the secondary coffee extract permeate (321) to obtain a recombined roast and ground coffee extract (390).

In some embodiments, said two-stage extraction process comprises an extraction process for the production of aqueous coffee extracts in which the extraction is carried out in two stages at different temperatures, as described in Example 3a. The extract obtained from the first stage is called primary aqueous coffee extract (301), while the extract from the second stage at higher temperature is called secondary aqueous coffee extract (310).

The filtration means is of the type as described for Example 1 and involves conventional membrane filtration system which comprises a membrane filtration, for example, with a cut off of about 50 kDa.

In some embodiments, the membrane cut off is less than 50 kDa, for example about 30 kDa, 20 kDa, 10 kDa or 5 kDa.

In the embodiment shown in FIG. 3b, the filtration means applied to the primary aqueous coffee extract (301) comprises a membrane filtration cut off of about 50 kDa, while no filtration is performed on the secondary aqueous coffee extract (310), before being sent to the pH-raising treatment. The pH-raising treatment is therefore applied to the whole secondary aqueous coffee extract (310), without previous separation of the high molecular weight (HMW) compounds into a secondary coffee extract retentate (not shown).

After the pH-raising treatment with alkaline agent to reduce the agonistic effect of the phenolic groups of the high molecular weight (HMW) compounds (responsible for the binding activity of the aroma compounds in coffee extracts), the resulting recombined roast and ground coffee extract (390) shows a reduced binding activity of HMW compounds towards the aroma compounds, resulting in a high content of free aroma compounds.

Said recombined roast and ground coffee extract (390) is then sent to conventional manufacturing processes for the production of ready to drink, liquid coffee concentrates and/or instant coffee powder.

The concentration and the packaging steps are carried out as described for Example 1.

### Example 4a

FIG. 4a shows a schematic of a flow diagram of a fifth example of a method according to the first aspect of the invention.

A two-stage extraction process is applied to roast and ground coffee powder (400), in an identical manner to that described hereinabove for Example 3a, to produce a primary aqueous coffee extract (40) which is stored for later use, and a secondary aqueous coffee extract (41). Said secondary aqueous coffee extract (41) is treated according to the first aspect of the invention, as described in Example 2. Said secondary aqueous coffee extract (41) is filtered to obtain a coffee extract permeate (42) and a coffee extract retentate (43). The coffee extract permeate (42) is stored for later use and the coffee extract retentate (43) is sent to a treatment with alkaline solution generating a treated coffee extract (44). Said treated coffee extract (44) is sent to a further filtration process to generate a secondary coffee extract retentate (47) and a waste permeate (46). Said secondary coffee extract retentate (47) is then recombined with the coffee extract permeate (42) to obtain a recombined roast and ground coffee extract (45) which is added to the primary aqueous coffee extract (40) providing a final recombined roast and ground coffee extract (49).

The secondary aqueous coffee extract (41) is produced through a conventional two-stage extraction method. Firstly, roast and ground coffee powder (400) is extracted with hot water at a first temperature in a range between 20° C. and 140° C., to produce the primary aqueous coffee extract (40). The roast and ground powder (spent ground) left after the extraction is then extracted again at a higher temperature between 170° C. and 220° C., to produce the secondary aqueous coffee extract (41). The extraction is carried out in a conventional extraction means (not shown), such as for example a packed column containing roast and ground coffee powder. The extraction can be carried out in batch or in continuum and a plurality of columns can be used to increase extraction yield. Hot water is sent into said column/columns through the roast and ground coffee powder from the top or alternatively from the bottom of the column/columns. Time of extraction varies on the base of the number of columns used, the grind size of the roast and ground coffee powder and the desired extraction yield. The content of HMW compounds in the secondary aqueous coffee extract (41) is in the range of 10 to 40%.

The secondary aqueous coffee extract (41) is then filtrated to generate a coffee extract permeate (42) which is stored for further use and a coffee extract retentate (43). The filtration means is of the type as described for Example 1 and involves conventional membrane filtration system which comprises a membrane filter, for example, with a cut off of about 50 kDa. The filtering process is carried out at a temperature of 20-70° C. and a pressure of 1-3 bar, for a period of time of 1-8 hours. Alternative filtration methods are available as described in Example 1 are available. The concentration of HMW compounds in the coffee extract retentate (43) is higher than the content of HMW compounds in the secondary aqueous coffee extract (41), particularly the content of HMW compounds in the coffee extract retentate (43) is more than double the concentration of HMW compounds in the secondary aqueous coffee extract (41). In some embodiments, the membrane cut off is less than about 50 kDa, for example 30 kDa, 20 kDa, 10 kDa or 5 kDa.

The coffee extract retentate (43) is sent for treatment with alkaline agent, reducing the concentration and the agonistic effect of the phenolic groups on the steric arrangement of the long chains of said high molecular weight (HMW) compounds, responsible for the binding activity of the aroma compounds in coffee extracts. As described for Example 1, the alkaline treatment comprises:
i. adding a solution of sodium hydroxide (NaOH) to the coffee extract retentate (43) and
ii. stirring for 30 to 180 minutes at a temperature of 30 to 100° C.
   The pH of the sodium hydroxide solution (NaOH) is in the range of 7 to 14, preferably 8 to 11 (concentration of 0.5-5 mol/L). Alternative alkaline agents are also used, for instance NaHCO₃, H₂CO₃ or KOH, as well as alternative resins and/or absorber treatments as described in Example 1.

The obtained treated coffee extract (44) shows a pH in the range of 4.9 to 5.8 post quenching and a reduced binding activity toward the aroma compounds.

The treated coffee extract (44) is then sent though conventional pipes system to a further filtration process to generate and separate a secondary extract retentate (47) from a waste permeate (46) comprising a fraction of coffee extract with primarily compounds with a molecular weight less than about 5 kDa (in the range of low molecular weight, LMW, compounds).

The filtering means of the further filtration step of FIG. 4a is a conventional membrane with a cut off of 1 kDa.

The resulting secondary coffee extract retentate (47) is then recombined with the coffee extract permeate (42) to result in the recombined roast and ground coffee extract (45) with a phenolic content less than the secondary aqueous coffee extract (41) and therefore with a reduced binding activity towards aromatic compounds compared to the secondary aqueous coffee extract (41).

Said recombined roast and ground coffee extract (45) is then added to the primary aqueous coffee extract (40) to provide the final recombined roast and ground coffee extract (49) which is then sent to conventional manufacturing processes for the production of ready to drink, liquid coffee concentrates and/or instant coffee powder.

The concentration and packaging steps are carried out with standard and commercially available methods as described for Example 1.

### Example 4b

FIG. 4b shows a schematic of a flow diagram of a sixth example of a method according to the first aspect of the invention.

A three-stage extraction process is applied to roast and ground coffee powder (401).

In general, a first extraction is undertaken to produce a primary aqueous coffee extract (440) and so-called “spent ground” (410). An aroma recovery process (900) is applied to the primary aqueous coffee extract (440) and an aroma is collected (not shown) and stored to be later reintroduced. A secondary extraction is performed on the spent ground (410) to produce a secondary aqueous coffee extract (441) and a secondary spent ground (480). On said secondary spent ground (480) a third extraction is carried out to obtain a tertiary coffee extract (482). Primary aqueous coffee extract (440) and secondary aqueous coffee extract (441), are both stored for later use. The tertiary aqueous coffee extract (482) is treated according to the first aspect of the invention, as described in Example 2. Said tertiary aqueous coffee extract (482) is filtered to obtain a coffee extract permeate (442) and a coffee extract retentate (443). The coffee extract permeate (442) is stored for later use and the coffee extract retentate (443) for pH-raising treatment to generate a treated coffee extract (444). Said treated coffee extract (444) is sent to a further filtration process to generate a quaternary coffee extract retentate (447) and a waste permeate (446). Said purified coffee extract retentate (447) is then recombined with the coffee extract permeate (442), the primary aqueous coffee extract (440) and the secondary aqueous coffee extract (441) to obtain a final recombined roast and ground coffee extract (449). The aroma collected through the aroma recovery process (900) is then reintroduced into the final recombined roast and ground coffee extract (449).

The detailed process of Example 4b is as follows.

The secondary (441) and tertiary aqueous coffee extract (482) are produced through a conventional three-stage extraction method. Firstly, roast and ground coffee powder (401) is extracted with hot water at a first temperature in a range between 20° C. and 140° C., to produce the primary aqueous coffee extract (440). The roast and ground powder (410) left after the extraction is then extracted again at a higher temperature between 170° C. and 220° C., to produce the secondary aqueous coffee extract (441) and the resultant secondary spent ground (480) which is then subjected to the third extraction at a temperature above 220° C. producing the tertiary aqueous coffee extract (482). The extraction is carried out in a conventional extraction means (not shown), such as for example a packed column containing roast and ground coffee powder. The extraction can be carried out in batch or in continuum and a plurality of columns can be used to increase extraction yield. Hot water is sent into said column/columns through the roast and ground coffee powder (401) from the top or alternatively from the bottom of the column/columns. Time of extraction varies on the base of the number of columns used, the grind size of the roast and ground coffee powder and the desired extraction yield. The content of HMW compounds in the tertiary aqueous coffee extract (482) is in the range of 1-10%.

The tertiary aqueous coffee extract (482) is then filtrated to generate a coffee extract permeate (442) which is stored for further use and a coffee extract retentate (443). The filtration means is of the type as described for Example 1 and involves conventional membrane filtration system which comprises a membrane filter, for example, with a cut off of about 10 kDa. The filtering process is carried out at a temperature of 15-70° C. and a pressure of 1-3 bar, for a period of time of 1-8 hours. Alternative filtration methods are available as described in Example 1 are available. The concentration of HMW compounds in the coffee extract retentate (443) is higher than the content of HMW compounds in the secondary (441) and primary aqueous coffee extract (440) particularly the content of HMW compounds in the coffee extract retentate (443) is more than double the concentration of HMW compounds in the secondary aqueous coffee extract (441). In other embodiments, the membrane cut off may less than about 30 kDa, 20 kDa, 10 kDa or 5 kDa.

The coffee extract retentate (443) is sent for pH-raising treatment using an alkaline agent, reducing the concentration and the agonistic effect of the phenolic groups on the steric arrangement of the long chains of said high molecular weight (HMW) compounds, responsible for the binding activity of the aroma compounds in coffee extracts. As described for Example 1, the alkaline treatment comprises:
i. adding a solution of sodium hydroxide (NaOH) to the coffee extract retentate (443) and
ii. stirring for 30 to 180 minutes at a temperature of 30 to 100° C.
   The pH of the sodium hydroxide solution (NaOH) is in the range of 7 to 14, preferably 8 to 11 (concentration of 0.5-5 mol/L). Alternative alkaline agents are also used, for instance KOH, as well as alternative resins and/or absorber treatments as described in Example 1.

The obtained treated coffee extract (444) shows a reduced binding activity toward the aroma compounds.

The treated coffee extract (444) is then sent though conventional pipes system to a further filtration process to generate and separate a purified coffee extract retentate (447) from a waste permeate (446), which comprises a fraction of coffee extract with primarily compounds with a molecular weight less than about 5 kDa (in the range of low molecular weight, LMW, compounds).

The filtering means of the further filtration step to isolate the waste permeate (446) of FIG. 4b is a conventional membrane with a cut off of 1 kDa.

The resulting purified coffee extract retentate (447) is then recombined with the coffee extract permeate (442) and the primary (440) and secondary (441) aqueous coffee extract to result in the final recombined roast and ground coffee extract (449) with a phenolic content less than the primary (440) and secondary (441) aqueous coffee extract and therefore with a reduced binding activity towards aromatic compounds compared to the said two aqueous coffee extracts (440, 441).

Said final recombined roast and ground coffee extract (449) is then sent to conventional manufacturing processes for the production of ready to drink, liquid coffee concentrates and/or instant coffee powder.

The concentration and packaging steps are carried out with standard and commercially available methods as described for Example 1.

### Example 4c

Referring to FIG. 4c, it represents a flow diagram of a seventh example of a method of the first aspect of the invention.

A three-stage extraction process is applied to roast and ground coffee powder (4010) as described in Example 4b. A primary aqueous coffee extract (4400) and a so-called “spent ground” (4100) are obtained through a first extraction stage. A secondary extraction is performed on the spent ground (4100) to produce a secondary aqueous coffee extract (4410) and a secondary spent ground (4800). On said secondary spent ground (4800) a third extraction is carried out to obtain a tertiary aqueous coffee extract (4820), which is collected and stored to be reintroduced later and a waste ground. Primary aqueous coffee extract (4400) and secondary aqueous coffee extract (4410) are both subjected to a filtration process, as described in Example 3b, to obtain a primary coffee extract retentate (4430), a secondary coffee extract retentate (4431), a primary coffee extract permeate (4460) and a secondary coffee extract permeate (4461). Said primary (4460) and secondary (4461) coffee extract permeates are stored for later use, while the primary coffee extract retentate (4430) and the secondary coffee extract retentate (4431) are treated in a pH-raising step according to the first aspect of the invention, obtaining a primary treated coffee extract (4470) and a secondary treated coffee extract (4471). Said primary (4470) and secondary (4471) treated coffee extract are then combined to provide a recombined treated coffee extract (4435). The tertiary aqueous coffee extract (4820) is finally added to said recombined treated coffee extract (4435), together with said primary (4460) and secondary (4461) coffee extract permeates to provide a final recombined roast and ground coffee extract (4439).

Optionally an aroma recovery step (not shown) may be undertaken on the primary aqueous coffee extract (4400) and the recovered aroma may be reintroduced into the final recombined roast and ground coffee extract (4439).

The secondary (4100) and tertiary aqueous coffee extract (4820) are produced through a conventional three-stage extraction method as described in Example 4b.

The content of HMW compounds in the tertiary aqueous coffee extract (4820) is in the range of 1% to 10%.

The filtration means is of the type as described for Example 1 and involves conventional membrane filtration system which comprises a membrane filter, for example, with a cut off of about 50 kDa. In some embodiments, the membrane cut off is less than about 50 kDa, for example 30 kDa, 20 kDa or 10 kDa. In some embodiments a sequence of membrane filtrations is applied with membranes cut off of about 50 kDa, 30 kDa, 20 kDa, 10 kDa and 5 KDa.

In the embodiment exemplified in FIG. 4c, the filtration means applied to the primary aqueous coffee extract (4400) comprises a membrane filtration cut off of about 50 kDa. No filtration is instead applied to the secondary aqueous coffee extract (4410), before being sent to the pH-raising treatment. pH-raising treatment is therefore applied to the whole secondary aqueous coffee extract (4410), without previous separation of the high molecular weight (HMW) compounds into a secondary coffee extract retentate (not shown).

In some embodiments (not shown) the tertiary aqueous coffee extract (4820) is subjected treated according to the invention providing a tertiary coffee extract permeate and a tertiary treated coffee extract which are then added to the final recombined roast and ground coffee extract.

The primary (4430) and secondary coffee extract retentate (4431) are sent for pH-raising treatment using an alkaline agent as described in Example 3b, to reduce the concentration and the agonistic effect of the phenolic groups on the steric arrangement of the long chains of said high molecular weight (HMW) compounds.

The resulting primary (4470) and secondary (4471) treated coffee extract are then recombined into the recombined treated coffee extract (4435) and added to the primary (4460) and secondary (4461) coffee extract permeates, to result in the final recombined roast and ground coffee extract (4439) with a phenolic content less than the primary (4400) and secondary (4410) aqueous coffee extracts combined together and therefore with a reduced binding activity towards aromatic compounds.

Said final recombined roast and ground coffee extract (4439) is then sent to conventional manufacturing processes for the production of ready to drink, liquid coffee concentrates and/or instant coffee powder.

The concentration and packaging steps are carried out with standard and commercially available methods as described for Example 1.

### Example 5

Referring to FIG. 5, it represents a flow diagram of an eighth example of a method of the first aspect of the invention.

An aqueous coffee extract (51) is filtrated to obtain a primary coffee extract permeate (52) and a primary coffee extract retentate (53). The primary coffee extract retentate (53) is stored for further use while the primary coffee extract permeate (52) is sent to a further filtration step to provide a secondary coffee extract retentate (520), stored for further use, and a secondary coffee extract permeate (521). The secondary coffee extract permeate (521) is sent to a subsequent filtration step to provide a tertiary coffee extract retentate (522), and a tertiary coffee extract permeate (523). The primary coffee extract retentate (53) and tertiary coffee extract retentate (522) are then treated separately with an alkaline solution to generate a primary treated coffee retentate (54) and a tertiary treated coffee retentate (540). Said treated coffee retentates (54, 540) are then recombined with said tertiary coffee extract permeate (523) to generate a recombined roast and ground coffee extract (55).

The sequence of filtrations of Example 5 is carried out by using a sequence of membranes in order to isolate fractions of the original aqueous coffee extract (51) comprising different molecular weight compounds ranges and then the fractions are treated individually, accordingly to the method of the invention, on the basis of the relevance and the level of affinity that each fraction has towards the volatile organic compounds (VOC), i.e. the aroma compounds. For example, a sequence of cut off above around 50 kDa (first filter—Filtering 1), above around 30 kDa (second filter—Filtering 2) and above around 10 kDa (third filter—Filtering 3) is used. The membrane with a cut off lower than the previous one allows isolation of a fraction of aqueous coffee extract with HMW compounds of reduced molecular weight. The filtration of each fraction of extract is carried out on the permeate of the previous filtration step. For example, the 30 kDa cut off membrane is used on the permeate coming from the 50 kDa membrane cut off and so on.

The roast and ground coffee extract (55) resulting from the method of the invention has a HMW fraction with reduced aroma binding compared to the aqueous coffee extract (51) thus a higher content of free aroma compounds (VOC).

The roast and ground coffee extract (55) resulting from the method of the invention can be used as such (for example for the production of Ready to Drink products) or sent to conventional concentration processes to obtain a liquid coffee concentrate to be sold as such in bag-in-box packaging or to be used in further drying processes (spray-drying or freeze drying) for the manufacturing of instant coffee powder with enhanced aroma level.

Reference HMW Binding Effect Study

The present invention is based on the finding that it is particularly advantageous to reduce the concentration of the phenolic groups on the steric arrangement of the long chains of said high molecular weight (HMW) compounds (such as for instance melanoidins) in an aqueous coffee extract as these groups are responsible for binding compounds such as HCAs, which play a key role in the aroma perception of a coffee beverage preparation. This binding activity results in a less aromatic beverage and therefore an inferior in-cup quality perception of said beverage by the consumer.

The binding activity of HMW compounds has been proven by the inventors through a ¹H-NMR spectroscopy analysis carried out on a beverage preparation obtained from commercially available coffee, as represented in FIG. 6.

Sample 1: a beverage preparation obtained from commercially available coffee concentrate at a concentration of 54 g/L was spiked with an aqueous solution 50 mmol/L of an aromatic compound (2,3-diethyl-5-methylpyrazine, earthy flavor).

Reference Sample 1: a comparative aqueous solution (with no coffee) spiked with an aqueous solution 50 mmol/L of an aromatic compound (2,3-diethyl-5-methylpyrazine, earthy flavor).

Sample 1 and the Reference Sample 1 were analysed via NMR spectroscopy for an incubation time of 30 minutes to verify the binding activity of phenolic groups of the HMW compounds present in the coffee beverage in respect to the spiked aromatic compound (2,3-diethyl-5-methylpyrazine).

In comparison to an aqueous solution (Reference Sample 1), the resonance signal of H-C(6) of Sample 1 showed a significant line broadening, indicating a binding between compounds, as well as a reduced intensity.

The NMR analyses clearly demonstrates a reduction of free 2,3-diethyl-5-methylpyrazine upon the incubation with the beverage preparation, indicative of binding of aromatic compounds by the HMW compounds.

The same experiment was carried out on a further sample obtained by a commercially available coffee brew, as represented in FIGS. 7a and 7b.

Sample 2: a beverage preparation obtained from commercially available coffee, brew of 54 g/L, treated with alkaline aqueous solution at a concentration of 2 g/L, was spiked with an aqueous solution 50 mmol/L of an aromatic compound (2,3-diethyl-5-methylpyrazine, earthy flavor), followed by a pH rising step for a period of 30 min at 60° C.

Reference Sample 2: a beverage preparation obtained from commercially available coffee, concentrated at a concentration of 54 g/L was spiked with an aqueous solution 50 mmol/L of an aromatic compound (2,3-diethyl-5-methylpyrazine, hazelnut flavor).

Sample 2 and the Reference Sample 2 were analysed via NMR spectroscopy for to verify the binding activity of phenolic groups of the HMW compounds present in the coffee beverage in respect to the spiked aromatic compound (2,3-diethyl-5-methylpyrazine).

FIG. 7a, which refers to untreated Reference Sample 2, shows a concentration of HMW compounds lower than the concentration of HMW compounds of FIG. 7b which relates to the treated Sample 2.

The NMR analyses demonstrate the high impact of alkaline treatment, and therefore the importance of affinity of HMW compounds (particularly coffee melanonids) for aroma compounds. The recovery rate of free 2,3-diethyl-5-methylpyrazine was elevated from 56% before the alkaline treatment to 84% after treatment.

### Example 6—Binding Effect Study of Example 4c

Table 1 below shows the increase in the recovery rate (% of free key aroma compound 2,3-diethyl-5-methylpyrazine) for several final recombined roast and ground coffee extracts as made according to the invention in Example 4c, when different treatment conditions are applied to the primary, secondary and tertiary aqueous extracts.

Each of the primary, secondary and/or tertiary aqueous coffee extracts made according to Example 4c were subjected to a either a sequence of membrane filtrations using a cut off of 50, 30, 10 and 5 kDa (hereinafter “total treated”) or to a single membrane of 50 kDa (hereinafter “single fraction treated”).

As described in Example 4c, the resulting fractionated retentates for each aqueous coffee extract were subjected to a pH-raising treatment according to the invention, to a pH of 13.

In addition, an aqueous solution of 2,3-diethyl-5-methylpyrazine at a concentration of 5.15 mol/L was used as Reference Sample. Said pyrazine is considered to be also a key aroma compound responsible for the earthy flavor in coffee brews.

After treatment according to the first aspect of the invention primary, secondary and tertiary treated coffee extracts were spiked with a pyrazine aqueous solution in order to obtain the same concentration as for the Reference Sample (5.15 mol/L).

Concentration of free pyrazine (%) was determined through ¹H-NMR, after incubation of 30 minute at room temperature.

Increase in recovery (%) was determined in comparison to the recovery of pyrazine in an untreated final roast and ground coffee extract, obtained by the combination of the primary, secondary and tertiary aqueous coffee extracts of Example 4c without any pH-raising treatment (hereinafter ‘untreated final extract’ or ‘untreated FE’), which represented the maximum pyrazine-binding condition (and thus minimum free aroma—the most detrimental to providing aroma complexity and effective in-cup performance).

TABLE 1
% recovery increase compared to untreated extract, for
extracts treated according to the invention in Example 4c and spiked
with pyrazine at the same concentration as Reference Sample No. 1.

| | | Increase in |
|---|---|---|
| | | recovery over |
| No | Sample | untreated FE [%] |
| 1 | Reference (aqueous | — |
| | pyrazine solution) | |
| 2 | untreated FE | N/A |
| 3 | Primary Coffee Extract | 12 |
| | Retentate total treated | |
| 4 | Primary Coffee Extract | 8 |
| | Retentate single fraction | |
| | treated (above 50 kDa) | |
| 5 | Secondary Coffee Extract | 7 |
| | Retentate total treated | |
| 6 | Tertiary Coffee Extract | 1 |
| | Retentate total treated | |
| 7 | Primary, Secondary, | 21 |
| | Tertiary Coffee Extract | |
| | Retentates total treated | |
| 8 | Primary Coffee Extract | 17 |
| | Retentate single fraction | |
| | treated (above 50 kDa) | |
| | and Secondary Coffee | |
| | Extract Retentate total | |
| | treated | |

Every recombined roast and ground coffee extract treated according to the first aspect of the invention showed a significant increase in the recovery % of free pyrazine compared to the untreated final extract, which confirms that treating the retentates of any stage of a one-, two- or higher stage extraction process, ensures an decrease in aroma-binding by HMW compounds. Especially effective was the treatment of HMW compounds higher than 50 kDa (i.e. using a filter with a cut-off of 50 kDa), which suggests that those HMW compounds have a disproportionate role in binding free aroma in extracts not treated according to the invention.

Sample No. 7 comprised the primary, secondary and tertiary extracts combined, each of the primary, secondary and tertiary retentates being made through filtration through a sequence of membrane filtrations using cut-offs of 50, 30, 10 and 5 kDa with the resulting fractions combined before the combined retentate is processed with pH-raising treatment according to the invention. Sample No. 7 showed a 21% increase in free pyrazine, which provides significant in-cup performance for the resulting instant coffee.

Even treating the coffee extract retentates using only a single membrane cut-off of 50 kDa results in a significant reduction of the overall binding effect in the final recombined roast and ground coffee extract (Sample Refs 4 and 8).

### Example 7—Binding Effect Study of Example 4c

The process of Example 6 was repeated, but raising the pH of the resulting >50 kDa fractionated retentates for each aqueous coffee extract to a pH of 8, 9, 10, 11 or 12. This resulted in a lower release of pyrazine than at pH 13. pH 8, 9, and 10 showed recovery of <5% compared to pH 13; pH 11 showed a recovery of approximately 20% pyrazine compared to pH13; and pH 12 showed recovery of approximately 90% pyrazine compared to pH 13. Whilst this resulted in retentates with more bound aroma, compared to raising the pH to 13, the method performed at pH 7-12, and particularly at 7-10, is more manageable on an industrial scale, when costs and processing issues are taken into consideration, and still provide far more release of aroma compounds and a subsequent beneficial improvement in aroma of the end coffee product compared to not raising the pH of the extract retentate, and so undertaking the methods of the invention by raising the pH of the extract retentate to anywhere between pH 7-13 is useful, depending on the ultimate application.

The above embodiments are described by way of example only. Many variants are possible without departing from the scope of the invention as defined in the appended claims.

1. A method of treating a beverage ingredient extract comprising the steps of:
a. filtering a beverage ingredient extract to obtain a beverage ingredient extract retentate and a beverage ingredient extract permeate;
b. raising the pH of said beverage ingredient extract retentate to provide a treated beverage ingredient extract retentate; and
c. combining said treated beverage ingredient extract retentate with said beverage ingredient extract permeate to generate a recombined ingredient extract.

2. A method according to claim 1 wherein the method further comprises, after step b) the step of filtering said treated beverage ingredient extract retentate to further purify it.

3. A method according to claim 1 wherein the method further comprises the steps of removing aroma volatile compounds from the beverage ingredient extract before step a) and adding or combining said volatile aroma compounds to/with the recombined ingredient extract after step c).

4. A method according to claim 3 wherein removing said aroma volatile compounds comprises stripping and/or steam distilling.

5. A method according to claim 1 wherein step a) is carried out at a temperature in the range of 20 to 100° C.

6. A method according to claim 1 wherein step a) is carried out at a pressure in the range of 1 to 3 bar.

7. A method according to claim 1 wherein the step a) is carried out by means of at least one filtering membrane.

8. A method according to claim 7 wherein said at least one membrane comprises at least one size exclusion cut off of at least 10 kDa.

9. A method according to claim 1 wherein performing step b) comprises raising the pH of the ingredient extract retentate to between 7 and 14, preferably between 7 and 10.

10. A method according to claim 1 wherein said raising the pH comprises treating the ingredient extract retentate with an aqueous alkaline solution, and/or resin and/or absorber treatment and/or a combination thereof.

11. A method according to claim 1 wherein performing step b) comprises treating the ingredient extract retentate with a pH-raising means for a period of time in the range of 10 to 180 minutes, preferably 30 to 90 minutes.

12. A method according to claim 1 wherein performing step b) comprises raising the temperature of the ingredient extract retentate to 30 to 100° C. while raising the pH.

13. A method according to claim 1 wherein the method further comprises the step of filtering the beverage ingredient extract permeate at least once, after step a), to produce further extract retentate and combining at least one further extract retentate and the beverage ingredient extract retentate before performing step b).

14. A method according to claim 13 wherein each repeat filtering of the beverage ingredient extract permeate comprises using a filtering member with reduced size exclusion cut off compared to any previous filter.

15. A method according to claim 1 wherein the method further comprises the step of filtering the generated recombined ingredient extract at least once, to provide a secondary beverage ingredient permeate and a secondary beverage ingredient retentate and raising the pH of said secondary beverage ingredient retentate.

16. A method according to claim 1 wherein the beverage ingredient extract comprises a primary extract from a primary extraction process of a roast and ground coffee powder, and/or a secondary extract extracted from a spent ground resulting from the primary extraction process, in a secondary extraction process and/or tertiary extract from the extraction of the resulting spent ground coffee powder from the secondary extraction process and/or a combination thereof.

17. A method according to claim 1 wherein the beverage ingredient extract comprises between 2% wt. and 15% wt. concentration of soluble solids.

18. A method according to claim 1 wherein the beverage ingredient extract comprises between 15% wt. and 80% wt. concentration of soluble solids.

19. A method according to claim 1 wherein the method further comprises the step of drying said recombined ingredient extract to generate a soluble beverage ingredient powder.

20. A method according to claim 1 wherein said beverage ingredient extract comprises extract obtained from a beverage ingredient selected from the group of coffee, cocoa, chicory, tea, and beer.

21. A method according to claim 1 wherein said recombined beverage ingredient extract is a soluble beverage ingredient powder.

22. A beverage ingredient extract obtained or obtainable by a method as claimed in claim 1.

23. A beverage ingredient extract according to claim 22 comprising between 2% wt. and 15% wt. concentration of soluble solids.

24. A beverage ingredient extract according to claim 22 comprising between 15% wt. and 80% wt. concentration of soluble solids.

25. A beverage ingredient extract as claimed in claim 22 wherein the beverage ingredient is selected from the group of coffee, cocoa, chicory, tea, and beer.

26. Use of a beverage ingredient extract comprising high molecular weight compounds, in which the high molecular weight compounds of above at least 10 kDa, 20 kDa, 30 kDa, and/or at least 50 kDa have been treated in a pH-raising step, to reduce aroma binding to said extract.

27. Use as claimed in claim 26, wherein the beverage ingredient extract is coffee extract.
